(19) United States
(12) Patent Application Publication
(10) Pub. No.: US 2016/0343300 A1
(43) Pub. Date: Nov. 24, 2016

(54) PIXEL CIRCUIT, DRIVING METHOD THEREOF, DISPLAY PANEL AND DISPLAY DEVICE

(71) Applicants: BOE TECHNOLOGY GROUP CO., LTD., Beijing (CN); ORDOS YUANSHENG OPTOELECTRONICS CO., LTD, Ordos, Inner Mongolia (CN)

(72) Inventors: Bo WANG, Beijing (CN); Minghua XUAN, Beijing (CN); Yi ZHANG, Beijing (CN)

(21) Appl. No.: 14/904,799

(22) PCT Filed: Apr. 17, 2015
(86) PCT No.: PCT/CN2015/076851

§ 371 Date: Jan. 13, 2016

(30) Foreign Application Priority Data
Jan. 29, 2015 (CN) 201510047143.2

(51) Int. Cl. G09G 3/3233

(52) U.S. Cl. CPC G09G 3/3233; G09G 2300/0819; G09G 2300/0842; G09G 2320/0233; G09G 2320/045; G09G 2310/0251

(57) ABSTRACT

The present invention provides a pixel circuit, a driving method thereof, a display panel and a display device. The pixel circuit comprises a first charging module, a storage capacitor, a second charging module, a reset module, a drive transistor, a light-emitting control module and a light-emitting device; the first charging module and the second charging module are respectively connected to two ends of the storage capacitor; the reset module is connected to both ends of the storage capacitor; a control electrode of the drive transistor is connected to the end of the storage capacitor connected to the second charging module, a first electrode thereof is connected to a high-voltage terminal, and a second electrode thereof is connected to the second charging module; and the light-emitting control module is connected between the drive transistor and the light-emitting device.

### FIELD OF THE INVENTION

The present invention relates to the field of liquid crystal display technology, and in particular to a pixel circuit, a driving method thereof, a display panel and a display device.

### BACKGROUND OF THE INVENTION

An active matrix organic light emitting diode (hereinafter referred to as AMOLED) display panel emits light of different brightness by using OLEDs so that pixels corresponding to the OLEDs display respective brightness. Compared with a traditional thin film transistor liquid crystal display (hereinafter referred to as TFT LCD) panel, the AMOLED display panel has a higher response speed, a higher contrast and a wider visual angle, and leads an important development direction of display panels.

A current for driving the OLEDs to emit light may be expressed by the following formula:

$${I}_{OLED} = \frac{β}{2} {( Vgs - Vth )}^{2}$$

Wherein Vgs is a voltage difference between the gate and the source of a drive transistor, β is a parameter related to a processing parameter and a feature dimension of the drive transistor, and Vth is a threshold voltage of the drive transistor.

According to the aforementioned formula, the driving current for driving a light-emitting device OLED to emit light is related to the threshold voltage Vth of the drive transistor. However, in practical applications, the threshold voltage Vth of the drive transistor will change in the light-emitting stage, thus to influence the brightness of light emitted by the light-emitting device OLED. As a result, the display effect of the AMOLED display panel will be negatively influenced.

### SUMMARY OF THE INVENTION

The present invention is intended to solve at least one of technical problems in the prior art and proposes a pixel circuit, a driving method thereof, a display panel and a display device, which can avoid that the brightness of light emitted by the light-emitting device is influenced by the change in the threshold voltage of the drive transistor during display, so that the brightness of light emitted by the light-emitting device is maintained stable during display.

In order to achieve the objective of the present invention, a pixel circuit is provided, including: a first charging module, a storage capacitor, a second charging module, a reset module, a drive transistor, a light-emitting control module and a light-emitting device; the first charging module and the second charging module are respectively connected to two ends of the storage capacitor and used for charging the two ends of the storage capacitor; the reset module is connected to both ends of the storage capacitor and used for respectively resetting voltages at the two ends of the storage capacitor as their initial voltages; a control electrode of the drive transistor is connected to the end of the storage capacitor connected to the second charging module, a first electrode thereof is connected to a high-voltage terminal, and a second electrode thereof is connected to the second charging module and used for driving the light-emitting device to emit light; and the light-emitting control module is connected between the second electrode of the drive transistor and the light-emitting device, and used for turning on or off a connection between the drive transistor and the light-emitting device.

The first charging module includes a front charging unit and a rear charging unit; the front charging unit is used for charging the storage capacitor after resetting the storage capacitor, so that the end of the storage capacitor connected to the first charging module has a first voltage; and the rear charging unit is used for charging the storage capacitor after the front charging unit charges the storage capacitor, so that the end of the storage capacitor connected to the first charging module has a second voltage.

The front charging unit includes a fourth transistor, a control electrode of the fourth transistor is connected to a gate line, a first electrode thereof is connected to a first data line which supplies the first voltage, and a second electrode thereof is connected to the end of the storage capacitor connected to the first charging module; and the rear charging unit includes a fifth transistor, a control electrode of the fifth transistor is connected to a light-emitting control signal terminal, a first electrode thereof is connected to a second data line which supplies the second voltage, and a second electrode is connected to the end of the storage capacitor connected to the first charging module.

The second charging module includes a second transistor; and a control electrode of the second transistor is connected to a gate line, a first electrode thereof is connected to the second electrode of the drive transistor, and a second electrode thereof is connected to the end of the storage transistor connected to the second charging module.

The reset module includes a first transistor and a seventh transistor; a control electrode and a first electrode of the first transistor are connected to a reset signal terminal, and a second electrode thereof is connected to the end of the storage capacitor connected to the second charging module; and a control electrode of the seventh transistor is connected to a reset signal terminal, a first electrode thereof is connected to a high-voltage terminal, and a second electrode thereof is connected to the end of the storage capacitor connected to the first charging module.

The light-emitting control module includes a sixth transistor, a control electrode of the sixth transistor is connected to the light-emitting control signal terminal, a first electrode thereof is connected to the second electrode of the drive transistor, and a second electrode thereof is connected to the light-emitting device.

The transistors are P-type transistors.

The light-emitting device is an OLED; and an anode of the OLED is connected to the second electrode of the sixth transistor, and a cathode thereof is connected to a low-voltage terminal.

As another technical solution, the present invention further provides a method for driving the pixel circuit, including:

in a first stage, respectively resetting voltages at the two ends of the storage capacitor as their initial voltages;

in a second stage, charging the end of the storage capacitor connected to the first charging module so that this end has a first voltage, and charging the end of the storage capacitor connected to the second charging module; and

in a third stage, charging the end of the storage capacitor connected to the first charging module so that this end has a second voltage and the end of the storage capacitor connected to the second charging module has a preset voltage, wherein a difference obtained by subtracting a voltage at a source of the drive transistor and a threshold voltage of the drive transistor from the preset voltage is a difference between the second voltage and the first voltage.

The transistors are P-type transistors; in the first stage, the light-emitting control signal terminal outputs a high level signal, the reset signal terminal outputs a low level signal, and the gate line outputs a high level signal; in the second stage, the light-emitting control signal terminal outputs a high level signal, the reset signal terminal outputs a high level signal, and the gate line outputs a low level signal; and in the third stage, the light-emitting control signal terminal outputs a low level signal, the reset signal terminal outputs a high level signal, and the gate line outputs a high level signal.

As yet another technical solution, the present invention further provides a display panel, including the pixel circuit provided by the present invention.

As still another technical solution, the present invention further provides a display device, including the display panel provided by the present invention.

The present invention has the following beneficial effects.

The pixel circuit provided by the present invention may avoid that the brightness of light emitted by the light-emitting device is influenced by the change in the threshold voltage of the drive transistor during display, and this facilitates maintaining the brightness of light emitted by the light-emitting device stable during display, thus improving the display effect.

The driving method provided by the present invention may avoid that the brightness of light emitted by the light-emitting device is influenced by the change in the threshold voltage of the drive transistor during display, and this facilitates maintaining the brightness of light emitted by the light-emitting device stable during display, thus improving the display effect.

The display panel provided by the present invention, by employing this pixel circuit provided by the present invention, may avoid that the brightness of light emitted by the light-emitting device is influenced by the change in the threshold voltage of the drive transistor during display, and this facilitates maintaining the brightness of light emitted by the light-emitting device stable during display, thus improving the display effect.

The display device provided by the present invention, by employing the display panel provided by the present invention, may avoid that the brightness of light emitted by the light-emitting device is influenced by the change in the threshold voltage of the drive transistor during display, and this facilitates maintaining the brightness of light emitted by the light-emitting device stable during display, thus improving the display effect.

### BRIEF DESCRIPTION OF THE DRAWINGS

The accompanying drawings are intended to provide further understanding of the present invention, constitute a part of the specification, and are used for explaining the present invention together with specific embodiments below, without limiting the present invention, in which:

FIG. 1 is a schematic structure diagram of a pixel circuit provided by an embodiment of the present invention;

FIG. 2 is a circuit diagram of the pixel circuit as shown in FIG. 1; and

FIG. 3 is a timing diagram of signals in the pixel circuit as shown in FIG. 2.

### REFERENCE NUMERALS

1: first charging module; 2: second charging module; 3: reset module; 4: light-emitting control module; 5: light-emitting device; 10: front charging unit; 11: rear charging unit; C: storage capacitor; T1: first transistor; T2: second transistor; T3: drive transistor; T4: fourth transistor; T5: fifth transistor; T6: sixth transistor; T7: seventh transistor; S1: first data line; S2: second data line; VDD: high-voltage terminal; VSS: low-voltage terminal; EM: light-emitting control signal terminal; RESET: reset signal terminal; Gate: gate line

### DESCRIPTION OF THE PREFERRED EMBODIMENTS

The specific embodiments of the present invention will be described below in detail with reference to the accompanying drawings. It should be understood that the specific embodiments described herein are merely used for describing and explaining the present invention, and not for limiting the present invention.

The present invention provides an embodiment of a pixel circuit. FIG. 1 is a structure diagram of the pixel circuit provided by the embodiment of the present invention. As shown in FIG. 1, the pixel circuit includes: a first charging module 1, a storage capacitor C, a second charging module 2, a reset module 3, a drive transistor T3, a light-emitting control module 4 and a light-emitting device 5, wherein the first charging module 1 and the second charging module 2 are respectively connected to two ends of the storage capacitor C and used for charging the two ends of the storage capacitor C; the reset module 3 is connected to both ends of the storage capacitor C and used for respectively resetting voltages at the two ends of the storage capacitor C as their initial voltages; a control electrode of the drive transistor T3 is connected to the end (i.e., the right end in FIG. 1) of the storage capacitor C connected to the second charging module 2, a first electrode thereof is connected to a high-voltage terminal VDD, and a second electrode thereof is connected to the second charging module 2 and used for driving the light-emitting device 5 to emit light; and the light-emitting control module 4 is connected between the second electrode of the drive transistor T3 and the light-emitting device 5, and used for turning on or off a connection between the drive transistor T3 and the light-emitting device 5.

In the pixel circuit provided by the embodiment, the reset module 3 resets both ends of the storage capacitor C first, so that the voltages at the two ends of the storage capacitor C are their initial voltages; and after the resetting process is completed, the first charging module 1 charges the end (i.e., the left end in FIG. 1) of the storage capacitor C connected to the first charging module 1 so that the left end of the storage capacitor C has a first voltage Vdata, the second charging module 2 charges the right end of the storage capacitor C so that the voltage at this end is VDD+Vth, wherein VDD is the voltage at the high-voltage terminal VDD and Vth is a threshold voltage of the drive transistor T3.

After the aforementioned processes are completed, the second charging module 2 stops charging the right end of the storage capacitor C, so that the storage capacitor C is in the following state: the voltage at the right end of the storage capacitor C changes as the voltage at the left end of the storage capacitor C changes. In this case, the first charging module 1 charges the left end of the storage capacitor C so that the left end of the storage capacitor C has a second voltage Vref. It may be understood that the voltage at the right end of the storage capacitor C, at this moment, will change correspondingly, and the voltage value should be: VDD+Vth+Vref−Vdata.

During this process, the light-emitting control module 4 controls the connection between the drive transistor T3 and the light-emitting device 5 to be turned off; however, after this process is completed, the light-emitting control module 4 controls the connection between the drive transistor T3 and the light-emitting device 5 to be turned on. At this moment, the current flowing from the drive transistor T3 to the light-emitting device 5 is:

$$\begin{matrix}I = \frac{β}{2} {( Vgs - Vth )}^{2} \\ = \frac{β}{2} {( VDD + Vth + Vref - Vdata - VDD - Vth )}^{2} \\ = \frac{β}{2} {( Vref - Vdata )}^{2}\end{matrix}$$

This current is the current for driving the light-emitting device 5 to emit light. It can be known from the aforementioned formula that this current is independent of the threshold voltage Vth of the drive transistor T3. Hence, the brightness of the light-emitting device 5 during display will not change due to the change in the threshold voltage Vth of the drive transistor T3. In this way, the stability of the brightness of light emitted by the light-emitting device 5 during display may be improved, and the display effect of the OLED display device is thus improved.

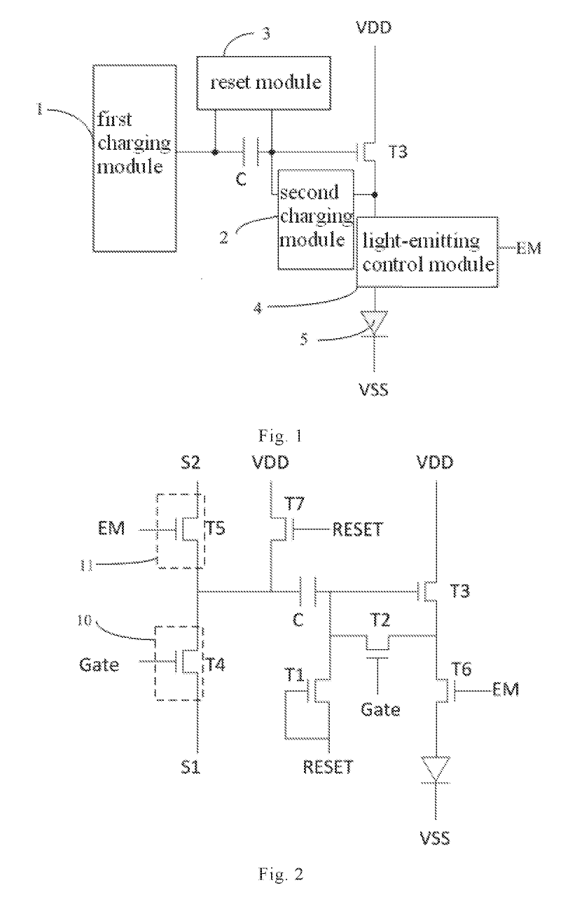

Specifically, as shown in FIG. 2, the first charging module 1 includes a front charging unit 10 and a rear charging unit 11; the front charging unit 10 is used for charging the storage capacitor C after the storage capacitor C is reset, so that the end (i.e., the left end in FIG. 2) of the storage capacitor C connected to the first charging module 1 has a first voltage Vdata; and the rear charging unit 11 is used for charging the storage capacitor C after the front charging unit 10 charges the storage capacitor C, so that the end of the storage capacitor C connected to the first charging module 1 has a second voltage Vref.

Further, the front charging unit 10 includes a fourth transistor T4, a control electrode of the fourth transistor T4 is connected to a gate line Gate, a first electrode thereof is connected to a first data line S1 which supplies the first voltage Vdata, and a second electrode thereof is connected to the end of the storage capacitor C connected to the first charging module 1; and the rear charging unit 11 includes a fifth transistor T5, a control electrode of the fifth transistor T5 is connected to a light-emitting control signal terminal EM, a first electrode thereof is connected to a second data line S2 which supplies the second voltage Vref, and a second electrode thereof is connected to the end of the storage capacitor C connected to the first charging module 1.

Then referring to FIG. 2, the second charging module 2 includes a second transistor T2; and a control electrode of the second transistor T2 is connected to a gate line Gate, a first electrode thereof is connected to the second electrode of the drive transistor T3, a second electrode thereof is connected to the end (i.e., the right end in FIG. 2) of the storage transistor C connected to the second charging module 2.

The reset module 3 includes a first transistor T1 and a seventh transistor T7, wherein a control electrode and a first electrode of the first transistor T1 are connected to a reset signal terminal RESET, and a second electrode thereof is connected to the end (i.e., the right end in FIG. 2) of the storage capacitor C connected to the second charging module 2; and a control electrode of the seventh transistor T7 is connected to a reset signal terminal RESET, a first electrode thereof is connected to a high-voltage terminal VDD, and a second electrode thereof is connected to the end (i.e., the left end in FIG. 2) of the storage capacitor C connected to the first charging module 1.

The light-emitting control module 4 includes a sixth transistor T6, a control electrode of the sixth transistor T6 is connected to the light-emitting control signal terminal EM, a first electrode thereof is connected to the second electrode of the drive transistor T3, and a second electrode thereof is connected to the light-emitting device 5. The light-emitting control signal terminal EM outputs a light-emitting control signal to the control electrode of the sixth transistor T6, so that the sixth transistor T6 can control ON or OFF of the connection between the drive transistor T3 and the light-emitting device 5.

The light-emitting device 5 is an OLED; and an anode of the OLED is connected to the second electrode of the sixth transistor T6, and a cathode thereof is connected to a low-voltage terminal VSS.

In this embodiment, it is to be noted that the control electrode of each of the transistors is the gate thereof, the first electrode and the second electrode respectively denote the source and drain thereof, wherein the first electrode may be the source and the second electrode may be the drain. Alternatively, the first electrode may be the drain and the second electrode may be the source.

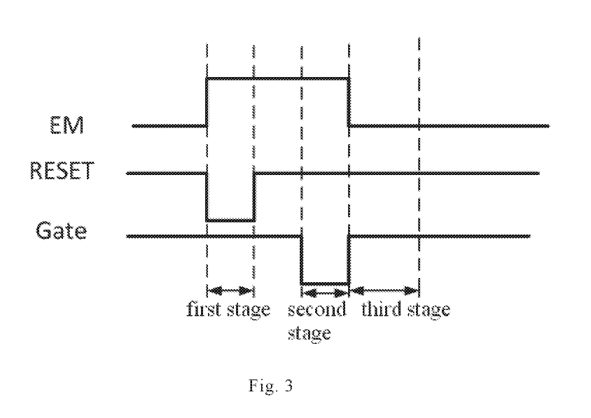

In this embodiment, the transistors may be P-type transistors. The principle and process of driving a pixel to emit light by the pixel circuit provided by the present invention will be described below in detail with reference to FIGS. 2 and 3, by taking the transistors being P-type transistors as an example.

First, in a first stage (reset stage), the light-emitting control signal terminal EM outputs a high level signal to turn off the fifth transistor T5 and the sixth transistor T6; the reset signal terminal RESET outputs a low level signal to turn on the first transistor T1 and the seventh transistor T7; the gate line Gate outputs a high level signal to turn off the second transistor T2 and the fourth transistor T4. That is to say, in the first stage, only the first transistor T1 and the seventh transistor T7 are in an ON state. In this case, the high-voltage terminal VDD charges the left end of the storage capacitor C through the seventh transistor T7 so that the end has a voltage VDD, the reset signal terminal RESET charges the right end of the storage capacitor C through the first transistor T1 so that the end has a voltage V_{RESET}, and the voltages VDD and V_{RESET} are respectively the initial voltages at the two ends of the storage capacitor C; and additionally, the voltage V_{RESET} will turn on the drive transistor T3 in a subsequent second stage.

Then, in the second stage, the light-emitting control signal terminal EM outputs a high level signal to turn off the fifth transistor T5 and the sixth transistor T6; the reset signal terminal RESET outputs a high level signal to turn off the first transistor T1 and the seventh transistor T7; and the gate line Gate outputs a low level signal to turn on the second transistor T2 and the fourth transistor T4. That is to say, in the second stage, only the second transistor T2, the fourth transistor T4 and the drive transistor T3 are in an ON state. In this case, the voltage Vdata of the first data line S1 is input to the left end of the storage capacitor C through the fourth transistor T4, so that the end has the voltage Vdata; and the high-voltage terminal VDD charges the right end of the storage capacitor C through the drive transistor T3 and the second transistor T2 until the voltage at the right end of the storage capacitor C reaches a voltage value sufficient to turn off the drive transistor T3. It can be known, according to the characteristics of diodes (the drive transistor T3 and the second transistor T2 form a diode structure), that the voltage at the right end of the storage capacitor C is VDD+Vth before the drive transistor T3 is turned off.

Subsequently, in the third stage, the light-emitting control signal terminal EM outputs a low level signal to turn on the fifth transistor T5 and the sixth transistor T6; the reset signal terminal RESET outputs a high level signal to turn off the first transistor T1 and the seventh transistor T7; and the gate line Gate outputs a high level signal to turn off the second transistor T2 and the fourth transistor T4. That is to say, in the third stage, only the fifth transistor T5 and the sixth transistor T6 are in the ON state. In this case, first, the voltage Vref of the second data line S2 is input to the left end of the storage capacitor C through the fifth transistor T5 to change the voltage at the end from Vdata to Vref. As the right end of the storage capacitor C is not connected to a power supply, the voltage at the right end of the storage capacitor C will change with the change in the voltage at the left end of the storage capacitor C. Finally, the voltage value at the right end of the storage capacitor C changes to VDD+Vth+Vref−Vdata from VDD+Vth.

According to the description above, in the third stage, the voltage at the gate of the drive transistor T3 (the potential thereof equals to that of the right end of the storage capacitor C) is: VDD+Vth+Vref−Vdata; and the voltage at the source of the drive transistor T3 is VDD. Therefore, the driving current generated according to the difference between the voltages at the gate and source of the drive transistor T3 is:

$$\begin{matrix}I = \frac{β}{2} {( Vgs - Vth )}^{2} \\ = \frac{β}{2} {( VDD + Vth + Vref - Vdata - VDD - Vth )}^{2} \\ = \frac{β}{2} {( Vref - Vdata )}^{2}\end{matrix}$$

The aforementioned driving current is input into the light-emitting device 5 through the sixth transistor T6, to drive the light-emitting device 5 to emit light. As the aforementioned driving current is independent of the threshold voltage Vth of the drive transistor T3, the brightness of light emitted by the light-emitting device 5 will not change due to the change in the threshold voltage Vth of the drive transistor T3. In this way, the stability of the brightness of light emitted by the light-emitting device 5 during display can be improved, and the display effect of the OLED display device is thus improved.

In conclusion, the pixel circuit provided by the embodiment of the present invention may avoid that the brightness of light emitted by the light-emitting device 5 is influenced by the change in the threshold voltage Vth of the drive transistor T3 during display, and this facilitates maintaining the brightness of light emitted by the light-emitting device 5 stable during display, thus improving the display effect.

An embodiment of the present invention further provides a method for driving a pixel circuit, and the driving method is used for the pixel circuit provided by the aforementioned embodiment of the present invention. In this embodiment, the driving method includes:

in a first stage, respectively resetting voltages at two ends of the storage capacitor as their initial voltages;

in a second stage, charging the end of the storage capacitor connected to the first charging module so that this end has a first voltage, and charging the end of the storage capacitor connected to the second charging module; and

in a third stage, charging the end of the storage capacitor connected to the first charging module so that this end has a second voltage and the end of the storage capacitor connected to the second charging module has a preset voltage, wherein a difference obtained by subtracting a voltage at a source of the drive transistor and a threshold voltage of the drive transistor from the preset voltage is a difference between the second voltage and the first voltage.

Specifically, as described in the aforementioned embodiment of the pixel circuit, in a case where the transistors (T1 to T7) are P-type transistors, in the first stage, the light-emitting control signal terminal EM outputs a high level signal, the reset signal terminal RESET outputs a low level signal, and the gate line Gate outputs a high level signal; in the second stage, the light-emitting control signal terminal EM outputs a high level signal, the reset signal terminal RESET outputs a high level signal, and the gate line Gate outputs a low level signal; and in the third stage, the light-emitting control signal terminal EM outputs a low level signal, the reset signal terminal RESET outputs a high level signal, and the gate line Gate outputs a high level signal.

Additionally, the specific processes of the first stage, the second stage and the third stage have been described in detail in the aforementioned embodiment of the pixel circuit, which will not be repeated herein.

The driving method provided by the embodiment of the present invention may avoid that the brightness of light emitted by the light-emitting device is influenced by the change in the threshold voltage of the drive transistor during display, and this facilitates maintaining the brightness of light emitted by the light-emitting device stable during display, thus improving the display effect.

One embodiment of the present invention further provides a display panel. In this embodiment, the display panel includes the pixel circuit provided by the aforementioned embodiment of the present invention.

The display panel provided by the embodiment of present invention, by employing the pixel circuit provided by the aforementioned embodiment of the present invention, may avoid that the brightness of light emitted by the light-emitting device is influenced by the change in the threshold voltage of the drive transistor during display, and this facilitates maintaining the brightness of light emitted by the light-emitting device stable during display, thus improving the display effect.

One embodiment of the present invention further provides a display device. In this embodiment, the display device includes the display panel provided by the aforementioned embodiment of the present invention.

The display device provided by the embodiment of present invention, by employing the display panel provided by the aforementioned embodiment of the present invention, may avoid that the brightness of light emitted by the light-emitting device is influenced by the change in the threshold voltage of the drive transistor during display, and this facilitates maintaining the brightness of light emitted by the light-emitting device stable during display, thus improving the display effect.

It may be understood that the aforementioned embodiments are merely exemplary embodiments and used for describing the principle of the present invention, and the present invention is not limited thereto. For a person of ordinary skill in the art, various variations and improvements may be made without departing from the spirit and essence of the present invention, and those variations and improvements should also be regarded as falling into the protection scope of the present invention.

1-12. (canceled)

13. A pixel circuit, comprising: a first charging module, a storage capacitor, a second charging module, a reset module, a drive transistor, a light-emitting control module and a light-emitting device;
wherein the first charging module and the second charging module are respectively connected to two ends of the storage capacitor and used for charging the two ends of the storage capacitor;
the reset module is connected to both ends of the storage capacitor and used for respectively resetting voltages at the two ends of the storage capacitor as their initial voltages;
a control electrode of the drive transistor is connected to the end of the storage capacitor connected to the second charging module, a first electrode thereof is connected to a high-voltage terminal, and a second electrode thereof is connected to the second charging module and used for driving the light-emitting device to emit light; and
the light-emitting control module is connected between the second electrode of the drive transistor and the light-emitting device, and used for turning on or off a connection between the drive transistor and the light-emitting device.

14. The pixel circuit according to claim 13, wherein the first charging module comprises a front charging unit and a rear charging unit;
the front charging unit is used for charging the storage capacitor after resetting the storage capacitor, so that the end of the storage capacitor connected to the first charging module has a first voltage; and
the rear charging unit is used for charging the storage capacitor after the front charging unit charges the storage capacitor, so that the end of the storage capacitor connected to the first charging module has a second voltage.

15. The pixel circuit according to claim 14, wherein the front charging unit comprises a fourth transistor, a control electrode of the fourth transistor is connected to a gate line, a first electrode thereof is connected to a first data line which supplies the first voltage, and a second electrode thereof is connected to the end of the storage capacitor connected to the first charging module; and
the rear charging unit comprises a fifth transistor, a control electrode of the fifth transistor is connected to a light-emitting control signal terminal, a first electrode thereof is connected to a second data line which supplies the second voltage, and a second electrode thereof is connected to the end of the storage capacitor connected to the first charging module.

16. The pixel circuit according to claim 15, wherein the second charging module comprises a second transistor, and
a control electrode of the second transistor is connected to a gate line, a first electrode thereof is connected to the second electrode of the drive transistor, and a second electrode thereof is connected to the end of the storage transistor connected to the second charging module.

17. The pixel circuit according to claim 16, wherein the reset module comprises a first transistor and a seventh transistor;
a control electrode and a first electrode of the first transistor are connected to a reset signal terminal, and a second electrode thereof is connected to the end of the storage capacitor connected to the second charging module; and
a control electrode of the seventh transistor is connected to a reset signal terminal, a first electrode thereof is connected to a high-voltage terminal, and a second electrode thereof is connected to the end of the storage capacitor connected to the first charging module.

18. The pixel circuit according to claim 17, wherein the light-emitting control module comprises a sixth transistor, a control electrode of the sixth transistor is connected to the light-emitting control signal terminal, a first electrode thereof is connected to the second electrode of the drive transistor, and a second electrode thereof is connected to the light-emitting device.

19. The pixel circuit according to claim 18, wherein the transistors are P-type transistors.

20. The pixel circuit according to claim 18, wherein the light-emitting device is an OLED; and an anode of the OLED is connected to the second electrode of the sixth transistor, and a cathode thereof is connected to a low-voltage terminal.

21. The pixel circuit according to claim 19, wherein the light-emitting device is an OLED; and an anode of the OLED is connected to the second electrode of the sixth transistor, and a cathode thereof is connected to a low-voltage terminal.

22. A method for driving a pixel circuit which is the pixel circuit according to claim 13, wherein the method comprises:
in a first stage, respectively resetting voltages at the two ends of the storage capacitor as their initial voltages;
in a second stage, charging the end of the storage capacitor connected to the first charging module so that this end has a first voltage, and charging the end of the storage capacitor connected to the second charging module; and
in a third stage, charging the end of the storage capacitor connected to the first charging module so that this end has a second voltage and the end of the storage capacitor connected to the second charging module has a preset voltage, wherein a difference obtained by subtracting a voltage at a source of the drive transistor and a threshold voltage of the drive transistor from the preset voltage is a difference between the second voltage and the first voltage.

23. A method for driving a pixel circuit which is the pixel circuit according to claim 19, wherein the method comprises:
in a first stage, outputting a high level signal by the light-emitting control signal terminal, outputting a low level signal by the reset signal terminal, and outputting a high level signal by the gate line, to respectively reset voltages at the two ends of the storage capacitor as their initial voltages;
in a second stage, outputting a high level signal by the light-emitting control signal terminal, outputting a high level signal by the reset signal terminal, and outputting a low level signal by the gate line, to charge the end of the storage capacitor connected to the first charging module so that this end has a first voltage, and to charge the end of the storage capacitor connected to the second charging module; and
in a third stage, outputting a low level signal by the light-emitting control signal terminal, outputting a high level signal by the reset signal terminal, and outputting a high level signal by the gate line to charge the end of the storage capacitor connected to the first charging module so that this end has a second voltage and the end of the storage capacitor connected to the second charging module has a preset voltage, wherein a difference obtained by subtracting a voltage at a source of the drive transistor and a threshold voltage of the drive transistor from the preset voltage is a difference between the second voltage and the first voltage.

24. A display panel, comprising the pixel circuit according to claim 13.

25. A display device, comprising the display panel according to claim 24.
